(19) United States
(12) Patent Application Publication
(10) Pub. No.: US 2024/0247486 A1
(43) Pub. Date: Jul. 25, 2024

(54) MOUNTING HARDWARE FOR CEILING SYSTEM

(71) Applicant: ARMSTRONG WORLD INDUSTRIES, INC., Lancaster, PA (US)

(72) Inventor: Ryan D. HANUSCHAK, Lancaster, PA (US)

(21) Appl. No.: 18/420,511

(22) Filed: Jan. 23, 2024

Related U.S. Application Data
(60) Provisional application No. 63/440,480, filed on Jan. 23, 2023.

(51) Int. Cl. E04B 9/24; E04B 9/22; F16B 7/04

(52) U.S. Cl. CPC E04B 9/245; E04B 9/225; F16B 7/0433

(57) ABSTRACT

Described herein is a mounting clip comprising: a mounting flange comprising a top surface opposite a bottom surface and a perimeter extending between the top surface and the bottom surface; a first positioning member extending upwards from the mounting flange; a second positioning member extending upwards from the mounting flange; a first hook member extending from the first positioning member; a second hook member extending from the second positioning member; wherein the mounting flange comprises a keyhole located inset from the perimeter of the mounting flange and extending continuously from the top surface to the bottom surface of the mounting flange.

### CROSS-REFERENCE TO RELATED APPLICATIONS

This application claims the benefit of U.S. Provisional Patent Application No. 63/440,480 filed on Jan. 23, 2023. The disclosure of the above application is incorporated herein by reference.

### BACKGROUND OF THE INVENTION

One type of ceiling system includes ceiling panels or tiles that are installed in a support grid or grille which may be suspended from or directly installed to a suitable overhead building support structure. Such ceiling systems may be designed to partially or completely conceal the support grid from view but may be difficult to install uniformly. Therefore, an improved mounting hardware to be used to improve use installation.

### SUMMARY OF THE INVENTION

The present invention provides a mounting clip comprising: a mounting flange comprising a top surface opposite a bottom surface and a perimeter extending between the top surface and the bottom surface; a first positioning member extending upwards from the mounting flange; a second positioning member extending upwards from the mounting flange; a first hook member extending from the first positioning member; a second hook member extending from the second positioning member; wherein the mounting flange comprises a keyhole located inset from the perimeter of the mounting flange and extending continuously from the top surface to the bottom surface of the mounting flange.

Other embodiments of the present invention include a mounting kit comprising: at least one of the previously mentioned mounting clips; at least one torsion spring; and a fastener comprising a head and a shaft, the head having a head diameter and the shaft having a shaft diameter.

Other embodiments of the present invention include a panel assembly comprising a body and having an upper surface opposite a lower surface and a first elongated side surface opposite a second elongated side surface, the first elongated side surface and the second elongated side surface extending between the upper surface and the lower surface of the body; at least one mounting clip comprising: a mounting flange comprising: a top surface opposite a bottom surface and a perimeter extending between the top surface and the bottom surface; a keyhole located inset from the perimeter of the mounting flange and extending continuously from the top surface to the bottom surface of the mounting flange; a first positioning member extending upwards from the mounting flange; a second positioning member extending upwards from the mounting flange; a first hook member extending from the first positioning member; a second hook member extending from the second positioning member; at least one fastener comprising: a head; and a shaft; and wherein the upper surface of the mounting flange is located is adjacent to the lower surface of the body; wherein the first positioning member is located adjacent to the first elongated side surface and the second positioning member is located adjacent to the second elongated side surface; wherein the shaft of the fastener is located at least partially within the keyhole of the mounting flange; and wherein the head of the fastener is located adjacent to the bottom surface of the mounting flange.

Other embodiments of the present invention include a ceiling system comprising at least one support member; a first torsion hook; a second torsion hook; at least one of the previously mentioned panel assemblies; and wherein panel assembly is coupled to the at least one support member by the first torsion hook and the second torsion hook such that the panel hangs vertically from the at least one support member via the mounting flange.

Other embodiments of the present invention include a method of assembling a panel assembly comprising: a) providing a mounting clip comprising a mounting flange having an upper surface opposite a lower surface and a keyhole that extends continuously between the upper surface and the lower surface of the mounting flange, and providing a pre-assembled grille assembly comprising at least one cross member having a body, the cross member comprising an upper surface opposite a lower surface; b) aligning the upper surface of the mounting clip with the lower surface of the cross member; c) driving a fastener through the keyhole of the mounting flange and into the body of the cross member such that the upper surface of the mounting flange contacts the lower surface of the cross member, and the cross member and mounting flange are held relative to each other by the fastener; and d) hanging the grille assembly from at least one support member via a torsion spring that is coupled to the mounting clip.

### BRIEF DESCRIPTION OF THE DRAWINGS

The features of the exemplary embodiments of the present invention will be described with reference to the following drawings, where like elements are labeled similarly, and in which:

FIG. 1 is a front top perspective view of a mounting clip for use in a ceiling system according to the present disclosure;

FIG. 2 is a rear bottom perspective view of the mounting clip of FIG. 1;

FIG. 3 is a top view of the mounting clip of FIG. 1;

FIG. 4 is a front elevation view of the mounting clip of FIG. 1;

FIG. 5 is a bottom view of the mounting clip of FIG. 1;

FIG. 6 is a side elevation view of the mounting clip of FIG. 1;

FIG. 7 is a perspective view of a partially assembled panel assembly comprising the mounting clip of FIG. 1;

FIG. 8 is a close-up view of region XLVIB of FIG. 7;

FIG. 9 is perspective view of a panel assembly comprising the mounting clip of FIG. 1;

FIG. 10 is a ceiling system comprising a plurality of the panel assemblies of FIG. 9;

FIG. 11 is a close up underside view of the ceiling system of FIG. 10; and

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION OF THE EMBODIMENTS

The features and benefits of the invention are illustrated and described herein by reference to exemplary embodiments. The following description of the preferred embodiment(s) is merely exemplary in nature and is in no way intended to limit the invention, its application, or uses.

This description of exemplary embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention.

Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Accordingly, the disclosure expressly should not be limited to such exemplary embodiments illustrating some possible non-limiting combination of features that may exist alone or in other combinations of features.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls. According to the present application, the term “about” means+/−5% of the reference value. According to the present application, the term “substantially free” less than about 0.1 wt. % based on the total of the referenced value.

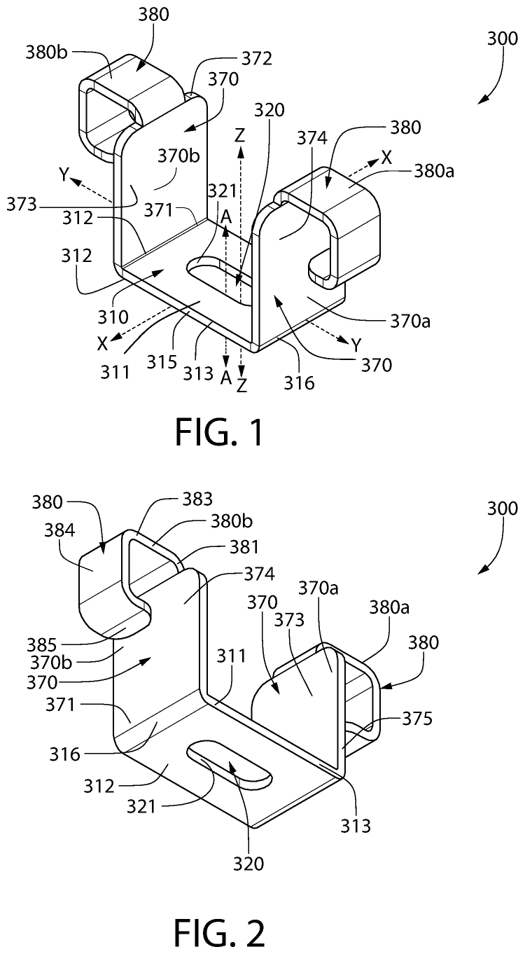

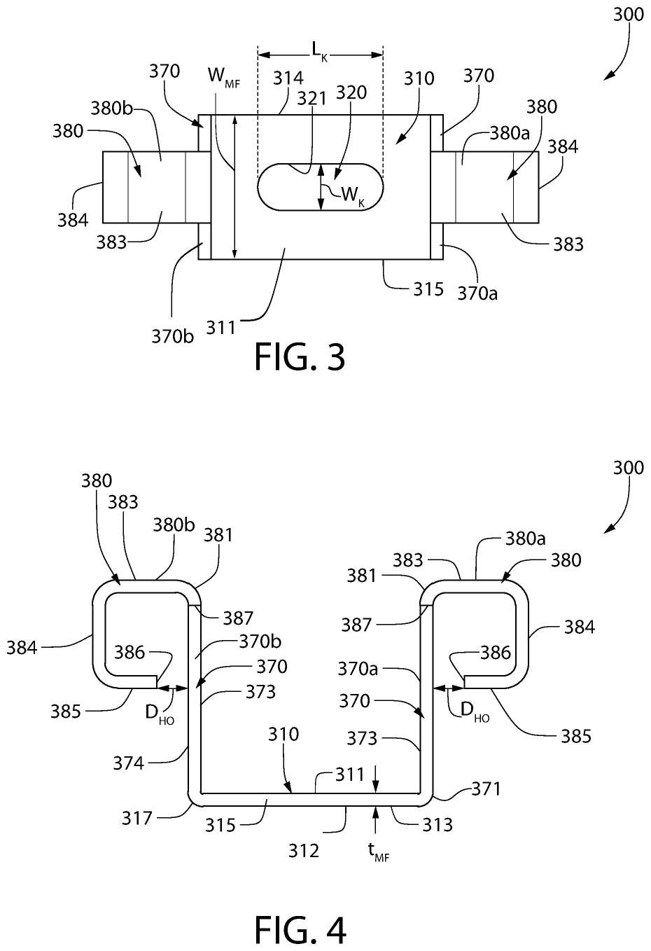

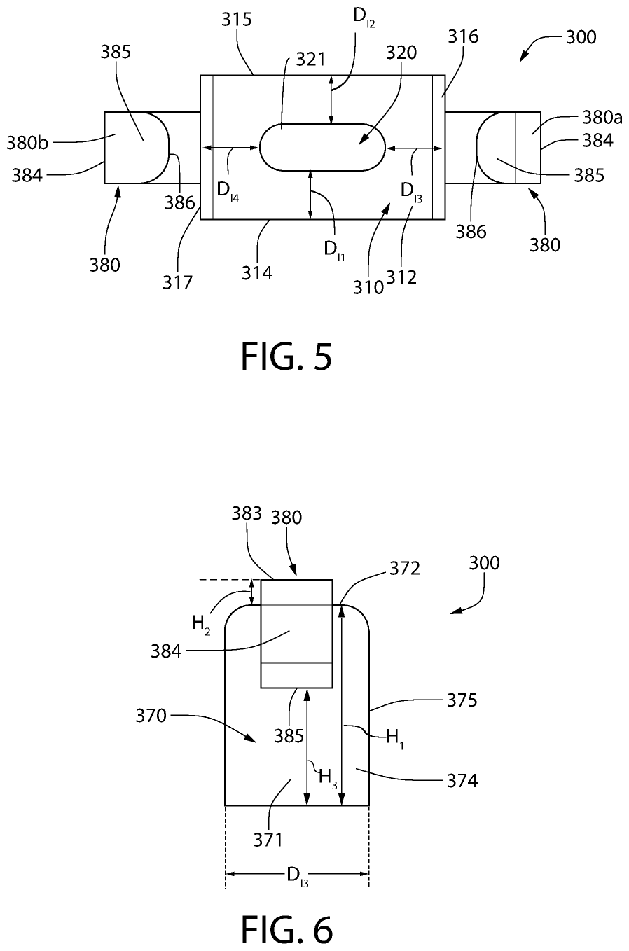

Referring FIGS. 1-6, a mounting clip 300 is described herein. In some embodiments, the mounting clip 300 may be referred to as a “panel mounting clip.” In some embodiments, the mounting clip 300 may be referred to as a “slat assembly mounting clip.” The mounting clip may be formed of a metal. Non-limiting examples of metals include steel, aluminum, and tin.

The mounting clip 300 may comprise a mounting flange 310. The mounting clip 300 may comprise at least one positioning member 370. The mounting clip 300 may comprise a grid engagement member 180. As discussed in greater detail herein, the mounting flange 310 may comprise a key hole 320. A first axis A-A may extend through the keyhole 320—as discussed in greater detail herein.

The mounting flange 310 may comprise a top surface 311 opposite a bottom surface 3112. The mounting flange 310 may comprise a perimeter 313 that extends between the top surface 311 and the bottom surface 312. The mounting flange 310 may have a thickness t_{MF} as measured by the distance between the top surface 311 and the bottom surface 312. The thickness t_{MF} of the mounting flange 310 may range from about 0.05 inch to about 0.095 inch—including all thickness and sub-ranges there-between.

The perimeter 313 may comprise a first edge 314 opposite a second edge 315. The perimeter may comprise a third edge 316 opposite a fourth edge 317. The first edge 314 may intersect the third edge 316 and the fourth edge 317. The second edge 315 may intersect the third edge 316 and the fourth edge 317. The first edge 314 and the second edge 315 may be substantially parallel. The third edge 316 and the fourth edge 317 may be substantially parallel. The first edge 314 may be substantially orthogonal to the third edge 316 and the fourth edge 317. The second edge 315 may be substantially orthogonal to the third edge 316 and the fourth edge 317.

The mounting clip 300 may be oriented about an X-axis, Y-axis, and Z-axis. The X-axis may intersect the first edge 314 and the second edge 315 of the perimeter 313 of the mounting flange 310. The Y-axis may intersect the third edge 316 and the fourth edge 317 of the perimeter 313 of the mounting flange 310. The Z-axis may intersect the top surface 311 and the bottom surface 312 of the mounting flange 310. The Z-axis and the first axis A-A may be parallel.

The mounting flange 310 may extend along a plane that is parallel to or coplanar with a plane formed by the X-axis and Y-Axis. The at least one positioning member 370 may extend along a plane that parallel to or coplanar with a plane formed by X-axis and Z-axis.

The mounting flange 310 may have a flange width W_{MF} as measured by the distance between the first edge 314 and the second edge 315. The flange width W_{MF} may range from about 0.5 inches to about 0.9 inches—including all widths and sub-ranges there-between. In some embodiments, the flange width W_{MF} may range from about 0.55 inches to about 0.75 inches—including all widths and sub-ranges there-between. In some embodiments, the flange width W_{MF} may range from about 0.65 inches to about 0.7 inches—including all widths and sub-ranges there-between.

The positioning member 370 may comprise a first positioning member 370a and a second positioning member 307b. Each of the first and second positioning members 370a, 370b may comprise a lower edge 371 opposite an upper edge 172. The lower edge 371 of the first positioning member 370a may be referred to as a first lower edge 371 and the upper edge 372 of the first positioning member 370b may be referred to as a first upper edge 372. The lower edge 371 of the second positioning member 370b may be referred to as a second lower edge 371 and the upper edge 372 of the second positioning member 370b may be referred to as a second upper edge 375.

Each positioning member 370 may comprise a first major surface 373 opposite a second major surface 374. The first major surface 373 and the second major surface 374 of the positioning member 370 may be substantially parallel. The first major surface 373 may extend vertically between the lower edge 371 and the upper edge 372. The second major surface 374 may extend vertically between the lower edge 371 and the upper edge 372.

The positioning member 370 may comprise a side surface 375. The side surface 3375 may extend vertically between the lower edge 371 and the upper edge 372 as well as extend horizontally between the first major surface 373 and the second major surface 374.

The positioning member 370 may extend upwards from the mounting flange 310. The lower edge 371 of the positioning member 370 may be located adjacent to the mounting flange 310, whereby the positioning member 370 extends upwards from the lower edge 371 to the upper edge 372.

The positioning member 370 may extend a positioning height H₁ as measured between the lower edge 371 and the upper edge 372. The first positioning member 370a may extend a first positioning height H₁ as measured between the first lower edge 371 and the first upper edge 372 of the first positioning member 370a. The second positioning member 370b may extend a second positioning height H₁ as measured between the second lower edge 371 and the second upper edge 372 of the second positioning member 370b. The first positioning height of the first positioning member 370a and the second positioning height of the second positioning member 370b may be substantially equal.

The first positioning member 370a and the second positioning member 370b may be being about the first axis A-A and offset by about 180 degrees as measured about the first axis A-A.

The positioning member 370 may be oriented substantially orthogonal to the mounting flange 310. The first major surface 373 of the positioning member 370 may be substantially orthogonal to the top surface 311 of the mounting flange 310. The first major surface 373 of the positioning member 370 may be substantially orthogonal to the bottom surface 312 of the mounting flange 310.

The mounting clip 300 may comprise at least hook member 380. The mounting clip 300 may comprise a first hook member 380a and a second hook member 380b. Each hook member 380 may extend upwards from the positioning member 370. The hook member 380 may extend upwards from the upper edge 372 of the positioning member 370. The hook member 380 may be a hanger, hook, or the like. The first hook member 380a may extend from the upper edge 372 of the first positioning member 370a. The second hook member 380b may extend from the upper edge 372 of the second positioning member 370b.

The first hook member 380a and the second hook member 380b may be being about the first axis A-A and offset by about 180 degrees as measured about the first axis A-A.

The hook member 380 may extend from a proximal end 387 and terminate at a distal end 386. The proximal end 387 of the hook member 380 may extend from the upper edge 372 of the positioning member 370. The proximal end 387 of the first hook member 380a may extend from the upper edge 372 of the first positioning member 370a. The proximal end 387 of the second hook member 380b may extend from the upper edge 372 of the second positioning member 370b.

The distal end 386 of the hook member 380 and the mounting flange 310 may not overlap along the Z-axis. The distal end 386 of the hook member 380 and the mounting flange 310 may overlap the positioning member 370 along the Y-axis. The distal end of the hook member 380 may be located vertically between the upper edge 372 and the lower edge 372 of the positioning member 370. The distal end of the first hook member 380a may be located vertically between the upper edge 372 and the lower edge 372 of the first positioning member 370a. The distal end of the second hook member 380b may be located vertically between the upper edge 372 and the lower edge 372 of the second positioning member 370b.

The distal end 386 of the hook member 380 may be horizontally offset from the second major surface 374 of the positioning member 370 by a hook offset distance D_{HO}. The hook offset distance D_{HO} may range from about 0.05 inches to about 0.25 inches—including all distances and sub-ranges there-between. In some embodiments, the hook offset distance D_{HO} may range from about 0.1 inches to about 0.2 inches—including all distances and sub-ranges there-between.

The distal end 386 of the first hook member 380a may be horizontally offset from the second major surface 374 of the first positioning member 370a by a first hook offset distance D_{HO}. The distal end 386 of the second hook member 380b may be horizontally offset from the second major surface 374 of the second positioning member 370b by a second hook offset distance D_{HO}. The first hook offset distance D_{HO} and the second hook offset distance D_{HO} may be substantially equal.

The distal end 386 of the hook member 380 may be vertically offset from the lower edge 371 of the positioning member 370 by a hook height H₃. The hook height H₃ may range from about 0.5 inches to about 0.8 inches—including all heights and sub-ranges there-between. In some embodiments, the hook height H₃ may range from about 0.6 inches to about 0.7 inches—including all distances and sub-ranges there-between.

The distal end 386 of the first hook member 380a may be vertically offset from the first lower edge 371 of the first positioning member 370a by a first hook height H₃. The distal end 386 of the second hook member 380b may be vertically offset from the second lower edge 371 of the second positioning member 370b by a second hook height H₃. The first hook height and the second hook height may be substantially equal.

A ratio of the positioning height H₁ to the hook height H₃ may range from about 1.5:1 to about 3.5:1—including all ratios and sub-ranges there-between. The ratio of the positioning height H₁ to the hook height H₃ may range from about 2:1 to about 3:1—including all ratios and sub-ranges there-between.

A ratio of the first positioning height H₁ of the first positioning member 370a to the first hook height H₃ of the first hook member 380a may range from about 1.5:1 to about 3.5:1—including all ratios and sub-ranges there-between. The ratio of the first positioning height H₁ of the first positioning member 370a to the first hook height H₃ of the first hook member 380a may range from about 2:1 to about 3:1—including all ratios and sub-ranges there-between.

A ratio of the second positioning height H₁ of the second positioning member 370b to the second hook height H₃ of the second hook member 380b may range from about 1.5:1 to about 3.5:1—including all ratios and sub-ranges there-between. The ratio of the second positioning height H₁ of the second positioning member 370b to the second hook height H₃ of the second hook member 380b may range from about 2:1 to about 3:1—including all ratios and sub-ranges there-between.

The hook member 380 may comprise a first offset portion 381, a clip portion 383, a front arm 384, and a second offset portion 385. The distal end 386 may be located on the second offset portion 385. The proximal end 385 may be located on the first offset portion 381. The distal end 386 may face towards the second major surface 374 of the positioning member 370. Specifically, the distal end 386 of the first hook member 380a may face the second major surface 374 of the first positioning member 370a and the distal end 386 of the second hook member 380b may face the second major surface 374 of the second positioning member 370b.

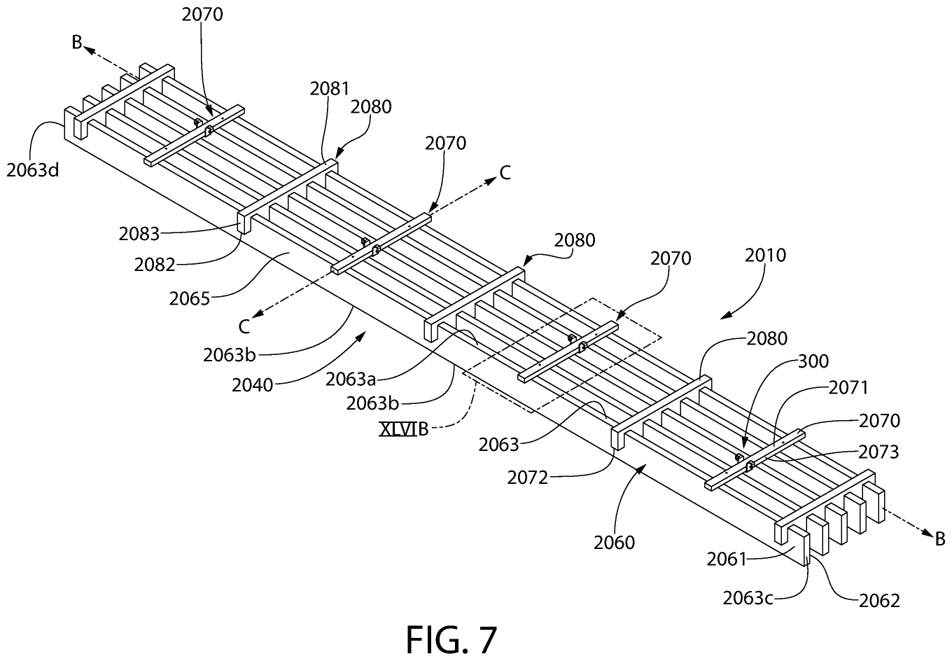

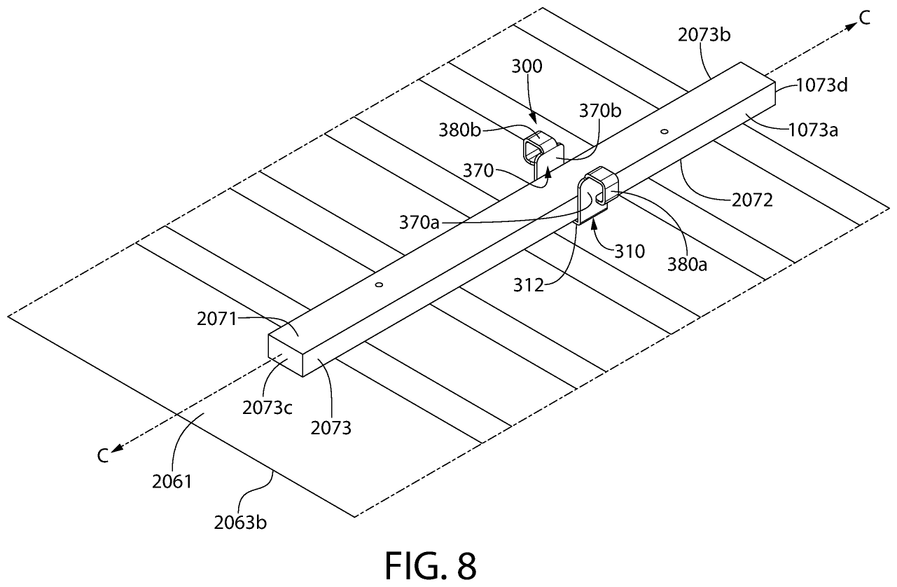

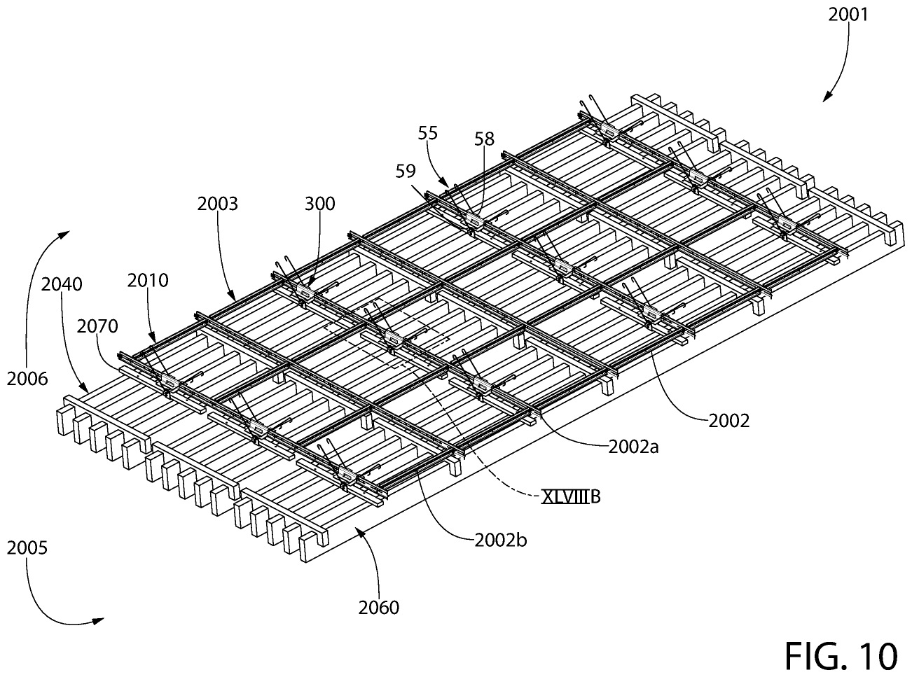

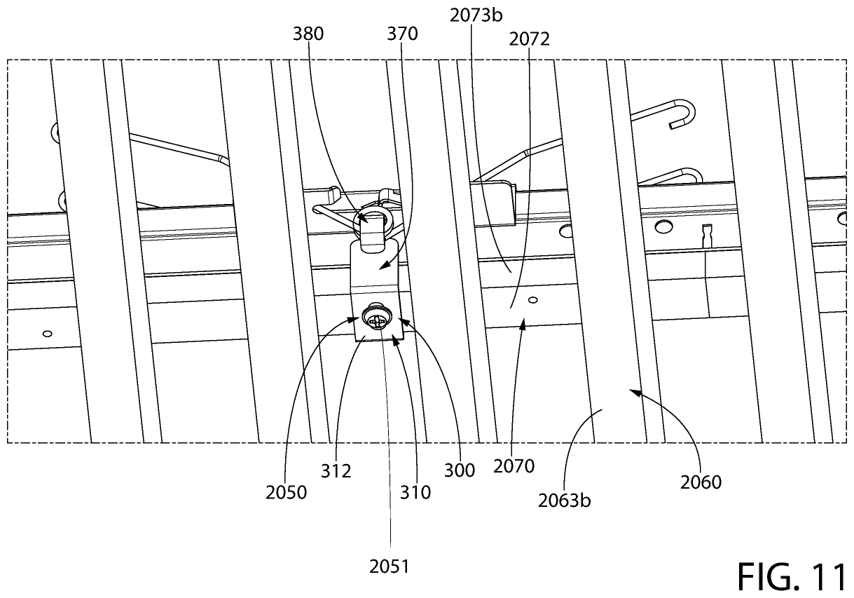

The clip portion 383 may extend between the first offset portion 381 and the front arm 384 and is flat, curved, or angled or shaped to coordinate with the shape of a loop portion 55 of a torsion spring 50 (as shown in FIGS. 7-11—discussed in greater detail herein). In one embodiment, the clip portion 383 and the front arm 384 are all configured to engage and secure the loop portion 55 of a torsion spring 50. In one embodiment, the clip portion 183, the rear arm 182, and the front arm 184 elastically deflect to engage the head portion 23 by a friction fit.

The hook member 380 may extend vertically above the upper edge 372 of the positioning member 370 to an extension height H₂ that ranges from about 0.05 inches to about 0.25 inches—including all heights and sub-ranges there-between. In some embodiments, the hook member 380 may extend vertically above the upper edge 372 of the positioning member 370 to an extension height H₂ that ranges from about 0.1 inches to about 0.15 inches—including all heights and sub-ranges there-between.

A ratio of the positioning height H₁ to the extension height H₂ may range from about 6.5:1 to about 9.5:1—including all ratios and sub-ranges there-between. The ratio of the positioning height H₁ to the hook height H₃ may range from about 7.5:1 to about 8.5:1—including all ratios and sub-ranges there-between. In some embodiments, the ratio of the positioning height H₁ to the hook height H₃ is about 8:1.

A ratio of the first positioning height H₁ of the first positioning member 370a to the first extension height H₂ of the first hook member 380a may range from about 6:1 to about 10:1—including all ratios and sub-ranges there-between. In some embodiments, the ratio of the first positioning height H₁ of the first positioning member 370a to the first extension height H₂ of the first hook member 380a may range from about 6.5:1 to about 9.5:1—including all ratios and sub-ranges there-between. The ratio of the first positioning height H₁ of the first positioning member 370a to the first extension height H₂ of the first hook member 380a may range from about 7.5:1 to about 8.5:1—including all ratios and sub-ranges there-between. The ratio of the first positioning height H₁ of the first positioning member 370a to the first extension height H₂ of the first hook member 380a may be about 8:1.

A ratio of the second positioning height H₁ of the second positioning member 370b to the second extension height H₂ of the second hook member 380b may range from about 6.5:1 to about 9.5:1—including all ratios and sub-ranges there-between. The ratio of the second positioning height H₁ of the second positioning member 370b to the second extension height H₂ of the second hook member 380b may range from about 7.5:1 to about 8.5:1—including all ratios and sub-ranges there-between. The ratio of the second positioning height H₁ of the second positioning member 370b to the second extension height H₂ of the second hook member 380b may be about 8:1.

The hook member 380 may comprise a first offset portion 381, a clip portion 383, a front arm 384, and a second offset portion 385. The distal end 386 may be located on the second offset portion 385. The proximal end 385 may be located on the first offset portion 381. The distal end 386 may face towards the second major surface 374 of the positioning member 370. Specifically, the distal end 386 of the first hook member 380a may face the second major surface 374 of the first positioning member 370a and the distal end 386 of the second hook member 380b may face the second major surface 374 of the second positioning member 370b.

The mounting flange 310 may comprise a keyhole 320. The keyhole 120 may extend continuously from the top surface 311 to the bottom surface 312 of the mounting flange 310. The keyhole 320 may be inset from the perimeter 313 of the mounting flange 310. The keyhole 320 may be inset from the perimeter 313 of the mounting flange 310 by a positive non-zero distance.

The keyhole 320 may be circumscribed by a keyhole wall 321. The keyhole wall 321 may extend continuously between the top surface 311 and the bottom surface 312 of the mounting flange 310. The keyhole wall 321 may have a height that is substantially equal to the thickness t_{MF} of the mounting flange 310.

The first axis A-A may extend through the keyhole 120. The first axis A-A may extend in a direction that is orthogonal to the bottom surface 312 of the mounting flange 310. The first axis A-A may extend in a direction that is substantially parallel to the keyhole wall 321. In a non-limiting embodiment, the first axis A-A may be centered on the keyhole 320. In other embodiments, the first axis A-A may not be centered on the keyhole 120 so long as it passes through the keyhole 120.

In a non-limiting embodiment, the keyhole 320 may be discorectangle in shape. The keyhole 320 may keyhole width W_{K} and a keyhole length L_{K}. The keyhole length L_{K} and the keyhole width W_{K} may not be equal. In some embodiments, the keyhole length L_{K} is greater than the keyhole width W_{K}. In alternative embodiments, the keyhole length L_{K} and the keyhole width W_{K} may be equal (not pictured).

The keyhole width W_{K} may range from about 0.15 inches to about 0.3 inches—including all widths and sub-ranges there-between. In some embodiments, the keyhole width W_{K} may range from about 0.2 inches to about 0.25 inches—including all widths and sub-ranges there-between. The keyhole length L_{K} may range from about 0.45 inches to about 0.75 inches—including all widths and sub-ranges there-between. In some embodiments, the keyhole length L_{K} may range from about 0.55 inches to about 0.7 inches—including all widths and sub-ranges there-between.

A ratio of the keyhole length L_{K} to the keyhole width W_{K} may range from about 2:1 to about 3.5:1—including all ratios and sub-ranges there-between. In some embodiments, the ratio of the keyhole length L_{K} to the keyhole width W_{K} may range from about 2.4:1 to about 3.0:1—including all ratios and sub-ranges there-between.

A ratio of the mounting flange width W_{MF} and the keyhole width W_{K} to the keyhole width W_{K} may range from about 2:1 to about 4:1—including all ratios and sub-ranges there-between. In some embodiments, the ratio of the keyhole length L_{K} to the keyhole width W_{K} may range from about 2.5:1 to about 3.5:1—including all ratios and sub-ranges there-between. In some embodiments, the ratio of the keyhole length L_{K} to the keyhole width W_{K} may be about 3:1.

The keyhole 320 of the mounting flange 310 may be inset from the first edge 314 of the perimeter 313 by a first inset distance D_{I1} that ranges from about 0.2 inches to about 0.3 inches—including all distances and sub-ranges there-between. In some embodiments, the first inset distance D_{I1} for the mounting flange 210 may range from about 0.225 inches to about 0.25 inches—including all distances and sub-ranges there-between.

The keyhole 320 of the mounting flange 210 may be inset from the second edge 315 of the perimeter 313 by a second inset distance D_{I2} that ranges from about 0.2 inches to about 0.3 inches—including all distances and sub-ranges there-between. In some embodiments, the second inset distance D_{I2} for the mounting flange 320 may range from about 0.225 inches to about 0.25 inches—including all distances and sub-ranges there-between.

The keyhole 320 for the mounting flange 210 may be inset from the third edge 316 of the perimeter 313 by a third inset distance D_{I3} that ranges from about 0.2 inches to about 0.3 inches—including all distances and sub-ranges there-between. In some embodiments, the third inset distance D_{I3} for the mounting flange 210 may range from about 0.2 inches to about 0.25 inches—including all distances and sub-ranges there-between.

The keyhole 220 for the mounting flange 310 may be inset from the fourth edge 317 of the perimeter 313 by a fourth inset distance D_{I4} that ranges from about 0.2 inches to about 0.3 inches—including all distances and sub-ranges there-between. In some embodiments, the fourth inset distance D_{I4} for the mounting flange 310 may range from about 0.2 inches to about 0.25 inches—including all distances and sub-ranges there-between.

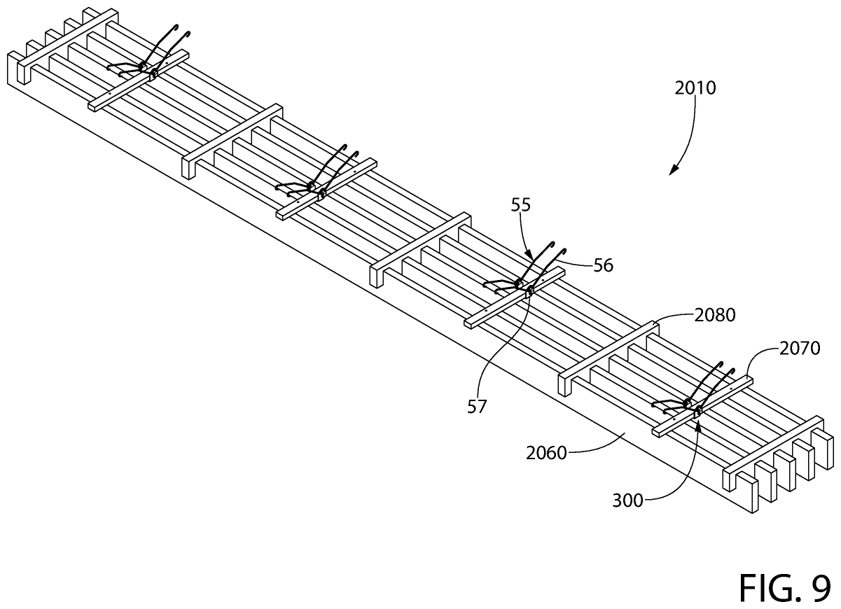

Referring now to FIG. 9, the present invention may further comprise a kit 90—the kit 90 comprising one or more of the mounting clip 300, one or more of a fastener 2050, and one or more torsion springs 50. The fastener 2050 may comprise a head 2051 and a shaft 2052.

Referring now to FIGS. 7-11, a ceiling structure assembly 2010 and ceiling system 2001 comprising the panel assembly 2010 as well as a method of forming the panel assembly 2010 and a method of installing the ceiling system 2001 is shown. The ceiling structure assembly 2010 may be a panel assembly 2010. The ceiling system 2001 comprising at least one of the panel assembly 2010 and at least one support member 2002.

The ceiling system 2001 may comprise a plurality of support members 2002 such that a first plurality of support members 2002a extend along a first longitudinal direction. The first plurality of support members 2002a may be parallel to each other. The plurality of support members 2002 may further include a second plurality of support members 2002b that extend transverse to the first longitudinal direction. The combination of the first plurality of support members 2002a and the second plurality of support members 2002b for a ceiling support grid 2003. An active room environment 2005 may be located beneath the ceiling support grid 2003 and a plenary space 2006 may be located above the ceiling support grid 2003.

The plenary space 2006 provides space for mechanical lines within a building (e.g., HVAC, plumbing, etc.). The active space 2005 provides room for the building occupants during normal intended use of the building (e.g., in an office building, the active space would be occupied by offices containing computers, lamps, etc.).

The at least one panel assembly 2010 may be coupled to at least one of the support members 2002. The at least one panel assembly 2010 may be suspended from the support members 2002 via torsion spring 55 engaged with both the mounting clip 300 and a saddle bracket 58 attached to the support members 2002. The saddle bracket 55 may comprise a receiving slot 59 having an opening to accept the legs 56 of the torsion spring 55. The support member 2002 may comprise an inverted T-bar 20 having a bottom flange and a head portion, whereby the saddle bracket 58 sits atop the head portion. In other embodiments not shown, the support member 2002 may comprise an integrally formed flange comprising the receiving slot having an opening to accept the legs 56 of the torsion spring 55.

The panel assembly 2010 may also be referred to as a “slat assembly”—whereby the slat assembly 2010. The slat assembly 2010 may comprise at least one grille assembly 2040. The grille assembly 2040 may comprise a plurality of slats 2060 and at least one of a first cross member 2070. In some embodiments, the grille assembly 2040 may comprise a plurality of slats 2060 and at least one of a first cross member 2070 and at least one of a second cross member 2080.

In alternative embodiments not shown, the ceiling structure assembly 2010 may be structure or an assembly of structures designed to be positioned within a ceiling system 2001 so long as such ceiling structure assembly 2010 comprises at least one of the first cross member 2070 for the mounting clip 300 to attach to—as discussed in greater detail herein.

Each one of the plurality of slats 2060 may comprise an elongated body 2065. Each one of the plurality of slats 2060 may comprise a first major surface 2061 opposite a second major surface 2062 and a side surface 2063 extending between the first major surface 2061 and the second major surface 2062. The side surface 21063 of each slat 2060 may comprise an upper side surface 2063a opposite a lower side surface 2063b and a first edge side surface 2063c opposite a second edge side surface 2063d. Each one of the slats 2060 may be positioned vertically such that the upper side surface 2063a faces the plenary space 2006 within the ceiling system 2001 and the lower side surface 2063b faces the active room environment 2005 within the ceiling system 2001. The first and second major surfaces 2061, 2062 of the plurality of slats 2060 may overlap along a horizontal direction within the ceiling system 2001.

Each one of the plurality of slats 2060 may be elongated and extend along a first longitudinal axis B-B that intersects the first edge side surface 2063c and the second edge side surface 2063d. The upper side surface 2063a and the lower side surface 2063b may extend substantially parallel to the first longitudinal axis B-B. The first major surface 2061 and the second major surface 2062 of each slat 2060 may extend substantially parallel to the first longitudinal axis B-B.

Each one of the plurality of first cross members 2070 may comprise a first body 2079. Each one of the plurality of first cross members 2070 may comprise an upper surface 2071 opposite a lower surface 2072 and a side surface 2073 extending between the upper surface 2071 and the lower surface 2072 of the first cross member 2070.

The side surface 2073 of the first cross member 2070 may comprise a first elongated side surface 2073a opposite a second elongated side surface 2073b and a first transverse side surface 2073c opposite a second transverse side surface 2073d. Each one of the first cross members 2070 may be positioned substantially orthogonal to the plurality of stats 2060. The first cross member 2070 may be elongated and extend along a second longitudinal axis C-C that intersects the first transverse side surface 2073c and the second transverse side surface 2073d. The first elongated side surface 2073a and the second elongated side surface 2073b may extend substantially parallel to the second longitudinal axis C-C. The upper surface 2071 and the lower surface 2072 of the first cross member 2070 may extend substantially parallel to the second longitudinal axis C-C.

The upper surface 2071 of the first cross member 2070 may face the plenary space 2006 within the ceiling system 2001 and the lower surface 2072 may face the active room environment 2005 within the ceiling system 2001. The plurality of slats 2060 may be positioned beneath the first cross member 2070 such that upper surface 2071 of the first cross member 2070 faces away from the plurality of slats 2060 while the lower surface 2072 of the first cross member 2070 faces the side surface 2063 of the of the slats 2060. Specifically, the plurality of slats 2060 may be positioned beneath the first cross member 2070 such that upper surface 2071 of the first cross member 2070 faces away from the plurality of slats 2060 while the lower surface 2072 of the first cross member 2070 faces the upper side surface 2063a of the of the slats 2060. The lower surface 2072 of the first cross member 2070 may contact the upper side surface 2063a of the slats 2060.

The first cross member 2070 and the plurality of slats 2060 may be coupled together by one or more fasteners 2014. The plurality of slats 2060 and the first cross member 2070 may be arranged such that the first longitudinal axis B-B and the second longitudinal axis C-C are substantially orthogonal.

Each one of the plurality of second cross members 2080 may comprise a second body 2089. Each one of the plurality of second cross members 2080 may comprise an upper surface 22081 opposite a lower surface 2082 and a side surface 2083 extending between the upper surface 2081 and the lower surface 2082 of the second cross member 2080. The first cross member 2070 and the second cross member 2080 may be arranged in an alternative pattern along the first longitudinal axis B-B of the plurality of slats 2060.

According to this embodiment, the mounting clip 300 may installed to, engage, and be coupled to the first cross member 2070 in a manner such that the mounting flange 310 of the mounting clip 300 may be adjacent to the lower surface 2072 of the first cross member 2070.

According to this embodiment, the upper surface 311 of the mounting flange 310 of the mounting clip 300 may be adjacent to the lower surface 2072 of the first cross member 2070. In some embodiments, the upper surface 311 of the mounting flange 310 may contact the lower surface 2072 of the first cross member 2070. Under this configuration, the grille assembly 2040 may be positioned substantially flush with the plurality of support members 2002, thereby minimizing the vertical space required for the grille assembly 2040 to exist within the ceiling system 2001 with respect to the support grid.

In the slat assembly 2010, at least one position member 370 of the mounting clip 300 may be adjacent to one of the first elongated side surface 2073a or the second elongated side surface 2073b of the first cross member 2070. In some embodiments, the at least one position member 370 of the mounting clip 300 may be in contact with one of the first elongated side surface 2073a or the second elongated side surface 2073b of the first cross member 2070.

In the slat assembly 2010, the first major surface 373 of the at least one position member 370 of the mounting clip 300 may be adjacent to one of the first elongated side surface 3073a or the second elongated side surface 3073b of the first cross member 3070. In some embodiments, the first major surface 373 of the at least one position member 370 of the mounting clip 300 may be in contact with one of the first elongated side surface 2073a or the second elongated side surface 2073b of the first cross member 2070.

In the panel assembly 2010, at least a portion of the hook member 380 may be located above the upper surface 2071 of the first cross member 2070. In the panel assembly 2010, at least the first offset portion 381 and the clip portion 383 may be located above the upper surface 2071 of the first cross member 2070.

In the panel assembly 2010, at least a portion of the torsion spring 55 may be located above the first cross member 2070. Leg portions 56 of the torsion spring 55 may be located above the first cross member 2070. The loop portion 57 of the torsion spring may be located above the first cross member 2070.

In the installed state, the weight of the grille assembly 2040 may be supported by the upper surface 311 of the mounting flange 310 of the mounting clip 300.

The fastener 2050 may extend through the keyhole 320 on the mounting clip 300 such that the head 2051 of the fastener is located beneath the lower surface 312 of the mounting flange 310 of the mounting clip 300 and the shaft 2052 of the fastener 2050 extends into the first body 2079 of the first cross member 2070—thereby securing the mounting clip 300 to the grille assembly 2040.

In some embodiments, the first cross member 2070 may comprise pre-drilled pilot holes for the mounting clip 300 and fastener 2050 to be positioned relative to during installation. The pre-drilled pilot holes may be factory-formed—i.e., comes supplied from the manufacturer with such holes to ensure precise location of the mounting clip 300 and fastener 2050 during installation.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A mounting clip comprising:
a mounting flange comprising a top surface opposite a bottom surface and a perimeter extending between the top surface and the bottom surface;
a first positioning member extending upwards from the mounting flange;
a second positioning member extending upwards from the mounting flange;
a first hook member extending from the first positioning member;
a second hook member extending from the second positioning member;
wherein the mounting flange comprises a keyhole located inset from the perimeter of the mounting flange and extending continuously from the top surface to the bottom surface of the mounting flange.

2. The mounting clip according to claim 1, wherein the perimeter of the mounting flange comprises a first edge opposite a second edge and a third edge opposite a fourth edge, wherein the first positioning member is adjacent the third edge and the second positioning member is adjacent the fourth member.

3. The mounting clip according to claim 1, wherein a first axis extends through the keyhole in a direction that is orthogonal to the bottom surface of the mounting flange, and wherein the first positioning member and the second positioning member are positioned about the first axis and offset by about 180 degrees as measured about the first axis.

4. The mounting clip according to claim 1, wherein the first hook member extends outward from the first positioning member in a direction away from the first axis.

5. The mounting clip according to claim 1, wherein the second hook member extends outward from the second positioning member in a direction away from the first axis.

6. The mounting clip according to claim 1, wherein the first hook member and the second hook member extend outward in opposite horizontally directions away from the first axis.

7. The mounting clip according to claim 1, wherein the keyhole comprises a discorectangle opening having a slot opening length and an slot opening width.

8. (canceled)

9. The mounting clip according to claim 1, wherein the first positioning member extends from a first lower edge to a first upper edge, and the first positioning member has a first positioning height as measured from the first lower edge to the first upper edge, and wherein the second positioning member extends from a second lower edge to a second upper edge, and the second positioning member has a second positioning height as measured from the second lower edge to the second upper edge.

10. The mounting clip according to claim 9, wherein the first hook member extends above the first upper edge by a first extension height and the second hook member extends above the second upper edge by a second extension height; and
wherein a ratio of the first positioning height to the first extension height ranges from about 6:1 to about 10:1.

11. The mounting clip according to claim 9, wherein the first positioning height and the second positioning height are substantially equal.

12. The mounting clip according to claim 9, wherein the first extension height and the second extension height are substantially equal.

13. The mounting clip according to claim 9, wherein the first hook member extends between a first proximal end to a first distal end, the first proximal end of the first hook member located adjacent to the first upper edge of the first positioning member, and wherein the second hook member extends between a second proximal end to a second distal end, the second proximal end of the second hook member located adjacent to the second upper edge of the second positioning member.

14. The mounting clip according to claim 13, wherein the first distal end of the first hook member is located vertically between the first upper edge and the first lower edge of the first positioning member, and wherein the first distal end of the first hook member is located vertically between the first upper edge and the first lower edge of the first positioning member.

15. The mounting clip according to claim 13, wherein the first distal end of the first hook member is horizontally offset from the first positioning member by a first hook offset distance and wherein the second distal end of the second hook member is horizontally offset from the first positioning member by a first hook offset distance.

16.-25. (canceled)

26. A panel assembly comprising
a body and having an upper surface opposite a lower surface and a first elongated side surface opposite a second elongated side surface, the first elongated side surface and the second elongated side surface extending between the upper surface and the lower surface of the body;
at least one mounting clip comprising:
a mounting flange comprising:
a top surface opposite a bottom surface and a perimeter extending between the top surface and the bottom surface;
a keyhole located inset from the perimeter of the mounting flange and extending continuously from the top surface to the bottom surface of the mounting flange;
a first positioning member extending upwards from the mounting flange;
a second positioning member extending upwards from the mounting flange;
a first hook member extending from the first positioning member;
a second hook member extending from the second positioning member;
at least one fastener comprising:
a head; and
a shaft; and
wherein the upper surface of the mounting flange is located is adjacent to the lower surface of the body;
wherein the first positioning member is located adjacent to the first elongated side surface and the second positioning member is located adjacent to the second elongated side surface;
wherein the shaft of the fastener is located at least partially within the keyhole of the mounting flange; and
wherein the head of the fastener is located adjacent to the bottom surface of the mounting flange.

27. The panel assembly according to claim 26, wherein the head of the fastener at least partially overlaps with the bottom surface of the mounting flange in a vertical direction.

28. The panel assembly according to claim 26, wherein at least a portion of the keyhole does not overlap with the head of the fastener in a vertical direction.

29. The panel assembly according to claim 26, wherein the keyhole comprises an opening length and an opening width, and wherein the head has a head diameter, the opening width is less than the head diameter.

30.-36. (canceled)

37. A method of assembling a panel assembly comprising:
a) providing a mounting clip comprising a mounting flange having an upper surface opposite a lower surface and a keyhole that extends continuously between the upper surface and the lower surface of the mounting flange, and providing a pre-assembled grille assembly comprising at least one cross member having a body, the cross member comprising an upper surface opposite a lower surface;
b) aligning the upper surface of the mounting clip with the lower surface of the cross member;
c) driving a fastener through the keyhole of the mounting flange and into the body of the cross member such that the upper surface of the mounting flange contacts the lower surface of the cross member, and the cross member and mounting flange are held relative to each other by the fastener; and
d) hanging the grille assembly from at least one support member via a torsion spring that is coupled to the mounting clip.

38. (canceled)

39. The method according to claim 37, wherein grille assembly of step a) comprises factory pre-drilled pilot holes on the cross member, whereby the factory pre-drilled pilot holes are located where the fastener is to be driven in during step c).
